(19) United States
(12) Patent Application Publication
(10) Pub. No.: US 2018/0220075 A1
(43) Pub. Date: Aug. 2, 2018

(54) SYSTEMS AND METHODS FOR PROVIDING A COLLAGE BASED ON SIMULTANEOUSLY CAPTURED IMAGES

(71) Applicant: Iván Eduardo Castro Calderón, Mexico City (MX)

(72) Inventor: Iván Eduardo Castro Calderón, Mexico City (MX)

(21) Appl. No.: 15/420,033

(22) Filed: Jan. 30, 2017

(51) Int. Cl. H04N 5/232; G06T 11/60; G06F 3/0484; H04L 12/58

(52) U.S. Cl. CPC H04N 5/23293; G06T 11/60; G06T 2207/20092; H04L 51/24; G06T 2207/20221; G06F 3/04842

(57) ABSTRACT

The present disclosure pertains to a system for providing a collage based on simultaneously captured images. In some implementations, the system may associate a plurality of users with an event. The system may receive a plurality of simultaneously captured images from a plurality of client computing devices associated with the plurality of users. The plurality of captured images may correspond to the event. The system may provide a collage based on the received images.

### FIELD OF THE DISCLOSURE

This disclosure relates to systems and methods for providing a collage based on simultaneously captured images.

### BACKGROUND

Conventional systems may facilitate creating collages based on a single user's existing photo library and/or an existing shared library between two or more users. The existing systems may require an individual user to select a plurality of previously captured images to create a collage. These systems may not facilitate creating a collage based simultaneously captured images. As such, these systems may not capture individual events experienced simultaneously by a plurality of users.

### SUMMARY

One aspect of the disclosure relates to a system for providing a collage based on simultaneously captured images. The system may include one or more processors configured by machine-readable instructions to associate a plurality of users with an event. The one or more processors may be configured by machine-readable instructions to receive a plurality of simultaneously captured images from a plurality of client computing devices associated with the plurality of users. The plurality of captured images may correspond to the event. The one or more processors may be configured by machine-readable instructions to provide a collage based on the received images.

Another aspect of the disclosure relates to a method for providing a collage based on simultaneously captured images. The method may include associating a plurality of users with an event. The method may include receiving a plurality of simultaneously captured images from a plurality of client computing devices associated with the plurality of users. The plurality of captured images may correspond to the event. The method may include providing a collage based on the received images.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing a collage based on simultaneously captured images, in accordance with one or more implementations.

FIG. 2 illustrates an exemplary implementation of event creation component, in accordance with one or more implementations.

FIG. 3 illustrates another exemplary implementation of event creation component, in accordance with one or more implementations.

FIG. 4 illustrates another exemplary implementation of event creation component, in accordance with one or more implementations.

FIG. 5 illustrates another exemplary implementation of event creation component, in accordance with one or more implementations.

FIG. 6 illustrates another exemplary implementation of event creation component, in accordance with one or more implementations.

FIG. 7 illustrates an exemplary implementation of image capture component, in accordance with one or more implementations.

FIG. 8 illustrates another exemplary implementation of image capture component, in accordance with one or more implementations.

FIG. 9 illustrates another exemplary implementation of image capture component, in accordance with one or more implementations.

FIG. 10 illustrates an exemplary implementation of collage creation component, in accordance with one or more implementations.

FIG. 11 illustrates another exemplary implementation of collage creation component, in accordance with one or more implementations.

FIG. 12 illustrates an exemplary implementation of silhouette creation component, in accordance with one or more implementations.

FIG. 13 illustrates a method for providing a collage based on simultaneously captured images, in accordance with one or more implementations.

### DETAILED DESCRIPTION

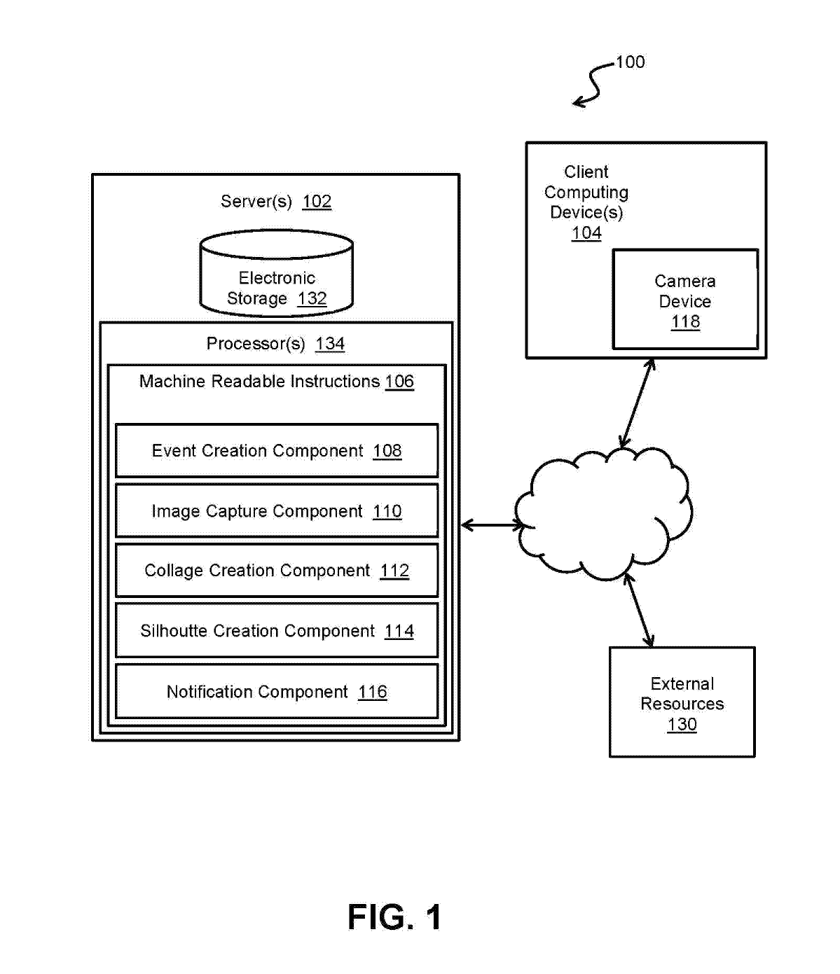

FIG. 1 illustrates a system 100 configured for providing a collage based on simultaneously captured images, in accordance with one or more implementations. In some implementations, system 100 may include one or more server(s) 102. The server(s) 102 may be configured to communicate with one or more client computing platforms 104 according to a client/server architecture, a peer-to-peer architecture, and/or other architectures. The users may access system 100 via client computing platform(s) 104.

The server(s) 102 may be configured to execute machine-readable instructions 106. The machine-readable instructions 106 may include one or more of an event creation component 108, an image capture component 110, a collage creation component 112, a silhouette creation component 114, a notification component 116, and/or other components.

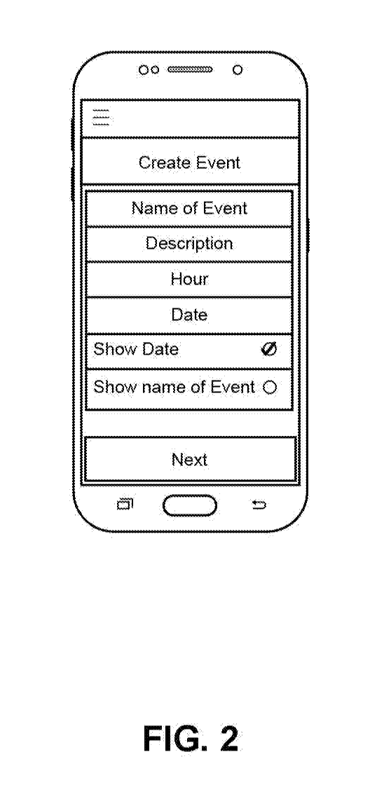

The machine-readable instructions 106 may facilitate providing a collage based on simultaneously captured images. In some implementations, event creation component 108 may facilitate creating an event by an administrator. In some implementations, the event may include an event name, an event description, an event date, an event time, and/or other attributes. In some implementations, the event may occur in multiple locations, across multiple time zones, and/or with varying durations. In some implementations, the event may correspond to an instantaneous moment in time. For example, the event may correspond to a New Year celebration (e.g., the time at which a new calendar year begins and the calendar's year count increments by one). In some implementations, the event may last for an extended duration of time. For example, the event may correspond to a wedding ceremony which may last three hours. In some implementations, event creation component 108 may facilitate selecting, changing, and/or modifying, by the administrator, one or both of a layout or aesthetics of the collage. By way of a non-limiting example, FIG. 2 illustrates an exemplary implementation of event creation component 108, in accordance with one or more implementations. In FIG. 2, event creation component 108 may facilitate entering, by the administrator, a name of an event, a description of the event, a time of the event, and a date of the event. Furthermore, as shown in FIG. 2, event creation component 108 may provide, to the administrator, one or more options to display the event name event date, and/or other options on the collage.

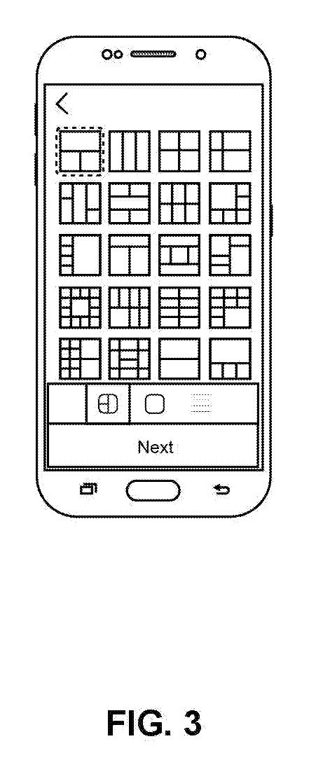

FIG. 3 illustrates another exemplary implementation of event creation component 108, in accordance with one or more implementations. As illustrated in FIG. 3, event creation component 108 may facilitate selection, modification, and/or change, by the administrator, a layout of the collage. The layout may be selected, modified, and/or changed based on a number of anticipated users.

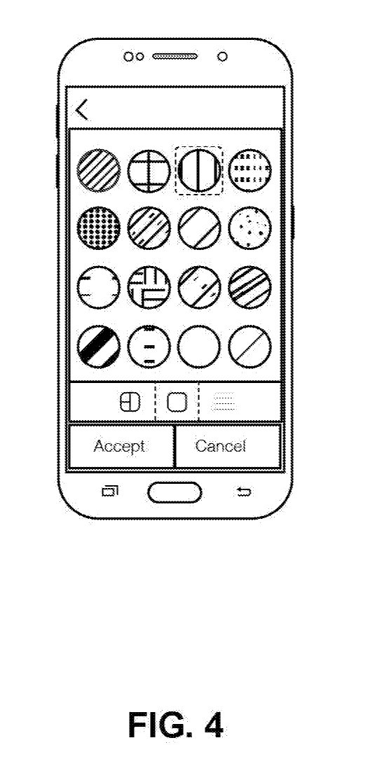

In some implementations, event creation component 108 may facilitate selection, modification, and/or change, by the administrator, a color of the collage. By way of a non-limiting example, FIG. 4 illustrates another exemplary implementation of event creation component 108, in accordance with one or more implementations. As shown in FIG. 4, event creation component 108 may facilitate the administrator to select a color and/or other aesthetic features associated with the collage.

In some implementations, event creation component 108 may enable the administrator to manually designate particular areas of the collage to individual ones of the plurality of users. In some implementations, event creation component 108 may automatically designate the plurality of users to particular areas of the collage.

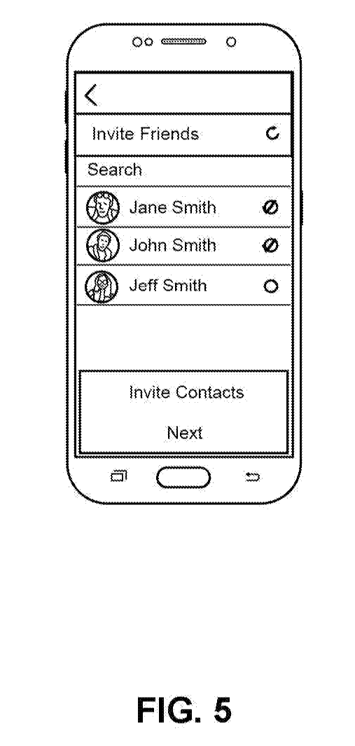

Returning to FIG. 1, event creation component 108 may facilitate the administrator to invite a plurality of users to the event. In some implementations, event creation component 108 may enable the administrator to add or remove one or more users from an event after an event has been created. By way of a non-limiting example, FIG. 5 illustrates another exemplary implementation of event creation component 108, in accordance with one or more implementations. In FIG. 5, event creation component 108 may facilitate the administrator to invite a plurality of users from a friends list, contact list, follower list, and/or other lists associated with the administrator. For example, event creation component 108 may facilitate inviting a plurality of users from the administrator's address book, Facebook friends list, and/or other resources.

In some implementations, event creation component 108 may facilitate the administrator to select one or more image filters to be applied to a plurality of simultaneously captured images received from a plurality of client computing devices 104 associated with the plurality of users. In some implementations, the one or more image filters may: change, modify, alter, and/or affect an appearance of the plurality of captured images and/or an appearance of at least a portion of each of the plurality of captured images. In some implementations, the one or more image filters may change, modify, alter, and/or affect the shades, colors, and/or other image attributes. In some implementations, the one or more image filters may increase and/or decrease: a brightness, a contrast, saturation, sharpness, and/or other image attributes. In some implementations, the one or more image filters may add a texture, a tone, and/or other special effects to the plurality of captured images. In some implementations, event creation component 108 may be configured to utilize one or more image filters built-in a client computing device associated with the administrator (e.g., mono, tonal, noir, fade, chrome, process, transfer, instant, and/or other filters on iOS) and/or utilize one or more third-party image filter plug-ins.

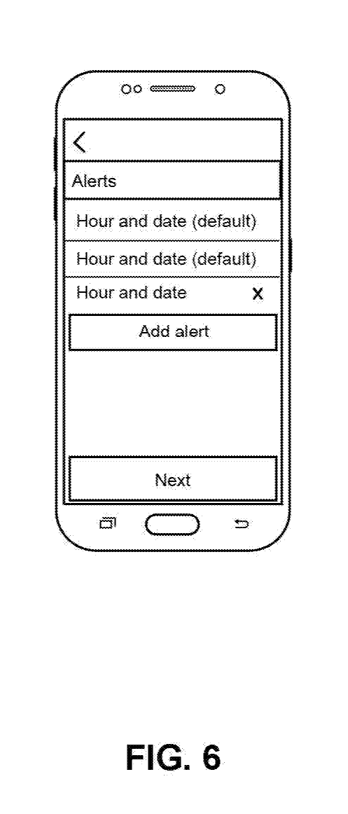

Returning to FIG. 1, event creation component 108 may facilitate the administrator to set up one or more alarms indicating an impending commencement of the event. For example, event creation component 108 may facilitate the administrator to set up a first alarm at one hour to event, a second alarm at half an hour to event, a third alarm at one minute to event, and/or other alarms. By way of a non-limiting example, FIG. 6 illustrates another exemplary implementation of event creation component 108, in accordance with one or more implementations. In FIG. 6, event creation component 108 may facilitate the administrator to set up one or more alerts by entering a time and date corresponding to the desired alert. As another example, event creation component 108 may provide an alarm at two minutes prior to the commencement of the event.

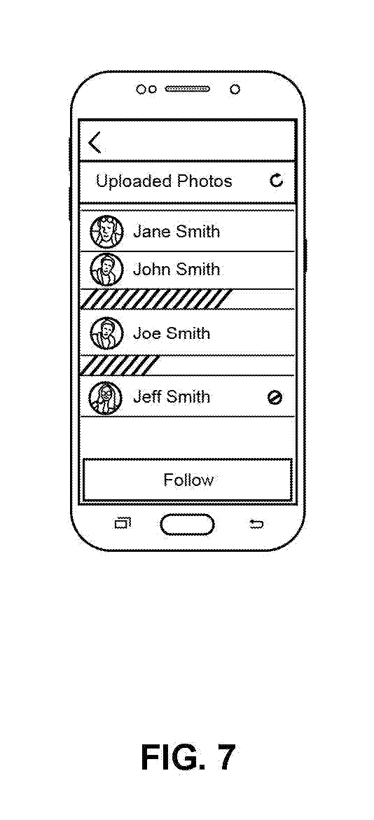

Returning to FIG. 1, image capture component 110 may be configured to receive a plurality of simultaneously captured images from a plurality of client computing devices 104 associated with the plurality of users. The plurality of captured images may correspond to the event. In some implementations, responsive to the event corresponding to an instantaneous moment in time, image capture component 110 may be configured to receive an image from each of the plurality of users. In some implementations, responsive to the event spanning an extended duration of time, image capture component 110 may be configured to receive one or more images from each of the plurality of users. For example, image capture component 110 may be configured to receive multiple images from each of the plurality of users during a wedding ceremony. By way of a non-limiting example, FIG. 7 illustrates an exemplary implementation of image capture component 110, in accordance with one or more implementations. As shown in FIG. 7, image capture component 110 may receive the plurality of captured images from the plurality of users. In some implementations, captured images may be obtained via a camera device 114 integrated within individual ones of the plurality of client computing devices 104.

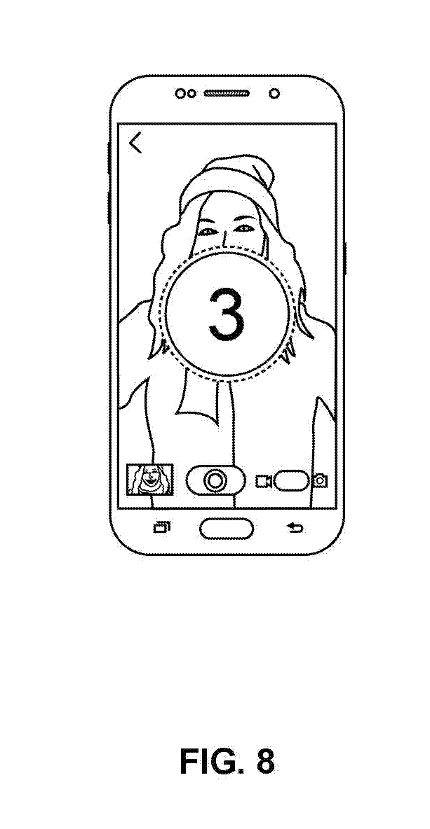

In some implementations, image capture component 110 may cause the plurality of client computing devices to automatically capture the plurality of images responsive to a commencement of the event. In some implementations, responsive to capturing the plurality of images, image capture component 110 may be configured to transmit the plurality of captured images to one or more processors 134. By way of a non-limiting example, FIG. 8 illustrates another exemplary implementation of image capture component 110, in accordance with one or more implementations. As shown in FIG. 8, image capture component 110 may automatically launch a camera user interface associated with individual ones of the plurality of client computing devices 104 and capture the plurality of images responsive to a commencement of the event.

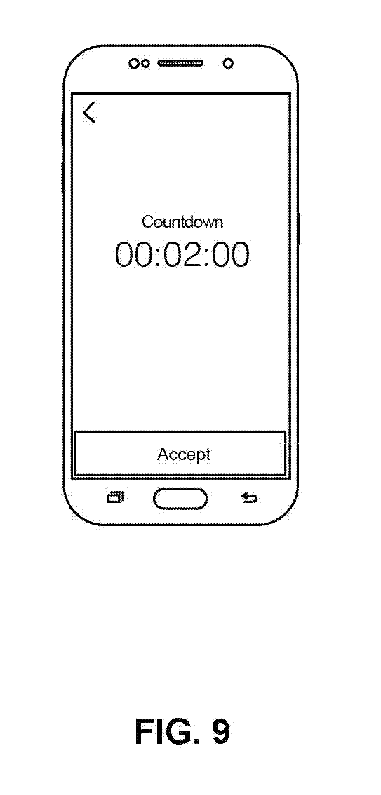

In some implementations, image capture component 110 may cause the plurality of client computing devices to display a countdown timer responsive to a time remaining to the event time reaching a threshold time. In some implementations, image capture component 110 may be configured to provide a predetermined threshold of time during which the plurality of users manually capture the images. By way of a non-limiting example, FIG. 9 illustrates another exemplary implementation of image capture component 110, in accordance with one or more implementations. In FIG. 9, image capture component causes a client computing device to display a countdown timer responsive to a time remaining to the event time reaching a threshold time (e.g., two minutes).

In some implementations, a particular area in the collage may be designated to each of the plurality of the users. In some implementations, the particular area may include a first dimension and a second dimension. In some implementations, image capture component 110 may notify each of the plurality of the users regarding the first dimension and the second dimension prior to the image being captured. For example, if a square area has been designated to a user, image capture component 110 may darken areas that may fall outside of a square grid (e.g., frame). As another example, image capture component 110 may notify the user to rotate the camera such that the captured image better fits the designated area on the collage.

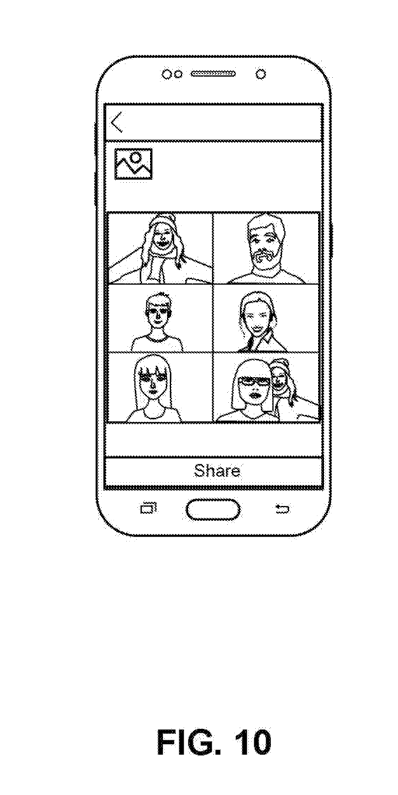

Returning to FIG. 1, collage creation component 112 may be configured to provide a collage based on the received images. In some implementations, collage creation component 112 may automatically adjust the collage layout based on a number of participating users (e.g., users that accepted the invitation to join the event). In some implementations, collage creation component 112 may place the received images in manually designated areas, automatically designated areas, randomly selected areas, and/or other areas within the collage. By way of a non-limiting example, FIG. 10 illustrates an exemplary implementation of collage creation component 112, in accordance with one or more implementations. As shown in FIG. 10, collage creation component 112 provides a collage using the received images based on the collage layout selected by the administrator and the desired arrangement of the received images (e.g., manually designated areas, automatically designated areas, randomly designated areas).

In some implementations, collage creation component 112 may facilitate the administrator to manually select one or more of the received images to be included in the collage. For example, the administrator may manually select 10 images from 50 received images to be included in the collage.

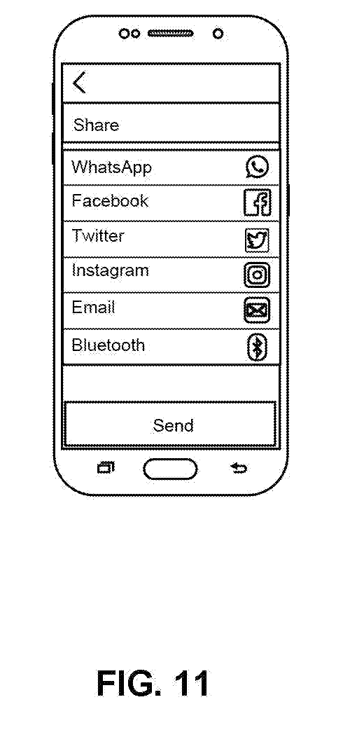

In some implementations, collage creation component 112 may facilitate sharing the collage between individual ones of the plurality of users, publishing the collage on one or more social media platforms, and/or other sharing options. By way of a non-limiting example, FIG. 11 illustrates another exemplary implementation of collage creation component 112, in accordance with one or more implementations. As shown in FIG. 11, collage creation component 112 may facilitate sharing the collage via WhatsApp, Facebook, Twitter, Instagram, email, Bluetooth, and/or other sharing options.

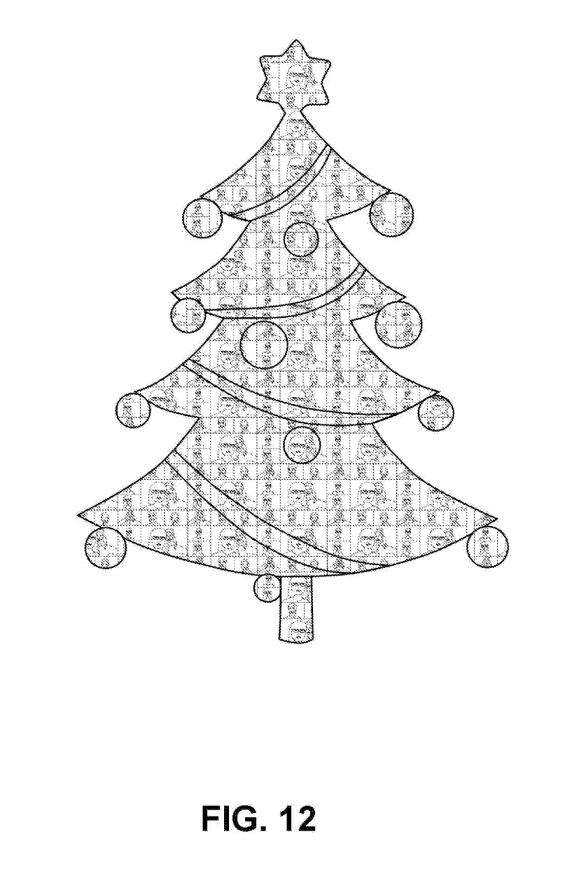

Returning to FIG. 1, silhouette creation component 114 may be configured to facilitate providing a silhouette mosaic from the received images. In some implementations, providing the silhouette mosaic includes (i) creating a mosaic pattern based on the received plurality of captured images, and (ii) filling at least a portion of a silhouette with the mosaic pattern. By way of a non-limiting example, FIG. 12 illustrates an exemplary implementation of silhouette creation component 114, in accordance with one or more implementations. As shown in FIG. 12, a mosaic pattern of a previously created collage is provided within a silhouette of an object (e.g., a tree and/or other object). The previously created collage may be based on the received plurality of captured images.

Notification component 116 may be configured to notify the plurality of users of the event via one or more of a text message, an instant message, or a social media platform notification. In some implementations, notifying the plurality of users may include providing an event code to the plurality of users. In some implementations, responsive to entering the event code in a user interface associated with one or more processors 134 by an individual one of the plurality of users, the individual one of the plurality of users may be added to a list of event participants. In some implementations, responsive to the an individual one of the plurality of the users not having a user interface associated with the one or more processors installed on the client computing device associated with the individual one of the plurality of the users, notification component 116 may be configured to facilitate installation of the user interface on the client computing device associated with the individual one of the plurality of the users. For example, notification component 116 may provide a link to the individual one of the plurality of users to download and install the user interface from an external resource (e.g., a software repository, an App Store) on client computing device 104 associated with the individual one of the plurality of the users.

In some implementations, server(s) 102, client computing device(s) 104, and/or external resources 130 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 130 may be operatively linked via some other communication media.

A given client computing device 104 may include one or more processors configured to execute computer program components. The given client computing device 104 may include a camera device 114 configured for capturing images. The computer program components may be configured to enable an expert or user associated with the given client computing device 104 to interface with system 100 and/or external resources 130, and/or provide other functionality attributed herein to client computing devices 104. By way of non-limiting example, the given client computing device 104 may include one or more of a desktop computer, a laptop computer, a handheld computer, a tablet computing platform, a NetBook, a Smartphone, a gaming console, and/or other computing platforms.

External resources 130 may include sources of information, hosts and/or providers of virtual environments outside of system 100, external entities participating with system 100, and/or other resources. In some implementations, some or all of the functionality attributed herein to external resources 130 may be provided by resources included in system 100. For example, external resources 130 may include one or more software repositories (e.g., Apple App Store, Google Play Apps).

Server(s) 102 may include electronic storage 132, one or more processors 134, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 132 may comprise non-transitory storage media that electronically stores information. The electronic storage media of electronic storage 132 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from server(s) 102, information received from client computing device(s) 104, and/or other information that enables server(s) 102 to function as described herein.

Processor(s) 134 is configured to provide information processing capabilities in server(s) 102. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. The processor(s) 134 may be configured to execute components 108, 110, 112, 114, 116, and/or other components. Processor(s) 134 may be configured to execute components 108, 110, 112, 114, 116, and/or other components by software; hardware; firmware; some combination of software, hardware, and/or firmware; and/or other mechanisms for configuring processing capabilities on processor(s) 134. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and 116 are illustrated in FIG. 1 as being implemented within a single processing unit, in implementations in which processor(s) 134 includes multiple processing units, one or more of components 108, 110, 112, 114, and 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As another example, processor(s) 134 may be configured to execute one or more additional components that may perform some or all of the functionality attributed below to one of components 108, 110, 112, 114, and/or 116.

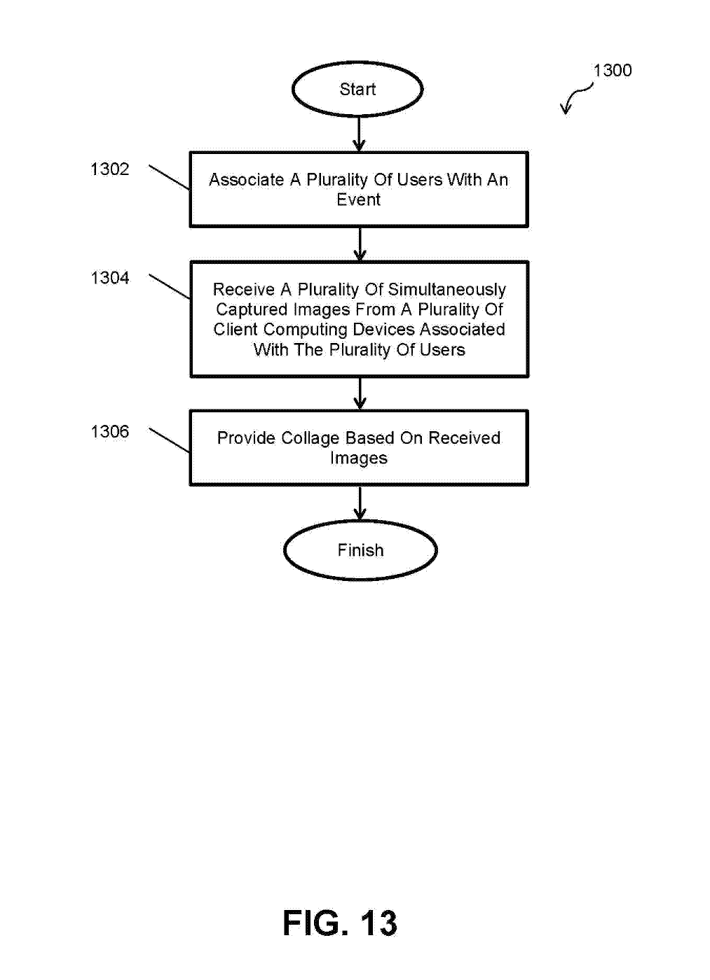

FIG. 13 illustrates a method 1300 for providing a collage based on simultaneously captured images, in accordance with one or more implementations. The operations of method 1300 presented below are intended to be illustrative. In some implementations, method 1300 may be accomplished with one or more additional operations not described, and/or without one or more of the operations discussed. Additionally, the order in which the operations of method 1300 are illustrated in FIG. 13 and described below is not intended to be limiting.

In some implementations, method 1300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300.

At an operation 1302, a plurality of users may be associated with an event. Operation 1302 may be performed by one or more hardware processors configured to execute a machine-readable instruction component that is the same as or similar to event creation component 108 (as described in connection with FIG. 1), in accordance with one or more implementations.

At operation 1304, a plurality of simultaneously captured images from a plurality of client computing devices associated with the plurality of users may be received. The plurality of captured images may correspond to the event. Operation 1304 may be performed by one or more hardware processors configured to execute a machine-readable instruction component that is the same as or similar to image capture component 110 (as described in connection with FIG. 1), in accordance with one or more implementations.

At operation 1306, a collage may be provided based on the received images. Operation 1306 may be performed by one or more hardware processors configured to execute a machine-readable instruction component that is the same as or similar to collage creation component 112 (as described in connection with FIG. 1), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for providing a collage based on simultaneously captured images, the system comprising:
a plurality of client computing devices, each comprising one or more processors configured by machine-readable instructions to:
designate one of said client computing devices as an administrator;
associate a plurality of users with an event that occurs at an administrator defined time and having an administrator defined duration;
receive a plurality of simultaneously captured images from the plurality of client computing devices associated with the plurality of users, the plurality of capture images corresponding to the event; and
provide a collage based on the received images.

2. The system of claim 1, wherein the one or more processors are further configured to cause the plurality of client computing devices to automatically capture the plurality of images responsive to a commencement of the event.

3. The system of claim 1, wherein the one or more processors are further configured to cause the plurality of client computing devices to display a countdown timer responsive to a time remaining to the event time reaching a threshold time.

4. The system of claim 1, wherein the one or more processors are further configured to facilitate selecting, changing, and/or modifying, by an administrator, one or both of a layout or aesthetics of the collage.

5. The system of claim 1, wherein the one or more processors are further configured to facilitate providing a silhouette mosaic from the received images.

6. The system of claim 5, wherein the one or more processors are configured such that providing the silhouette mosaic includes (i) creating a mosaic pattern based on the received plurality of captured images, and (ii) filling at least a portion of a silhouette with the mosaic pattern.

7. The system of claim 1, wherein the one or more processors are further configured to notify the plurality of users of the event via one or more of a text message, an instant message, or a social media platform notification.

8. The system of claim 7, wherein the one or more processors are configured such that notifying the plurality of users includes providing an event code to the plurality of users.

9. The system of claim 1, wherein the one or more processors are further configured to facilitate an administrator to invite the plurality of users to the event.

10. The system of claim 9, wherein the one or more processors are configured to, responsive to the an individual one of the plurality of the users not having a user interface associated with the one or more processors installed on the client computing device associated with the individual one of the plurality of the users, facilitate installation of the user interface on the client computing device associated with the individual one of the plurality of the users.

11. The system of claim 1, wherein the one or more processors are configured such that a particular area in the collage is designated to each of the plurality of the users, wherein the particular area includes a first dimension and a second dimension, and wherein each of the plurality of the users is notified of the first dimension and the second dimension prior to the image being captured.

12. A method for providing a collage based on simultaneously captured images, the method comprising:
designating a client computing device, from a plurality of user computing devices, as an administrator;
associating a plurality of users with an event that occurs at an administrator defined time and having an administrator defined duration;
receiving a plurality of simultaneously captured images from a plurality of client computing devices associated with the plurality of users, the plurality of captured images corresponding to the event; and
providing a collage based on the received images.

13. The method of claim 12, further comprising causing the plurality of client computing devices to automatically capture the plurality of images responsive to a commencement of the event.

14. The method of claim 12, further comprising causing the plurality of client computing devices to display a countdown timer responsive to a time remaining to the event time reaching a threshold time.

15. The method of claim 12, further comprising facilitating selecting, changing, and/or modifying, by an administrator, one or both of a layout or aesthetics of the collage.

16. The method of claim 12, further comprising facilitating providing a silhouette mosaic from the received images.

17. The method of claim 16, wherein providing the silhouette mosaic includes (i) creating a mosaic pattern based on the received plurality of captured images, and (ii) filling at least a portion of a silhouette with the mosaic pattern.

18. The method of claim 12, further comprising notifying the plurality of users of the event via one or more of a text message, an instant message, or a social media platform notification.

19. The method of claim 18, wherein notifying the plurality of users includes providing an event code to the plurality of users.

20. The method of claim 12, further comprising facilitating an administrator to invite the plurality of users to the event.

21. The method of claim 20, further comprising facilitating installation of the user interface on the client computing device associated with the individual one of the plurality of the users responsive to the an individual one of the plurality of the users not having a user interface associated with the one or more processors installed on the client computing device associated with the individual one of the plurality of the users.

22. The method of claim 12, wherein a particular area in the collage is designated to each of the plurality of the users, wherein the particular area includes a first dimension and a second dimension, and wherein the method further comprises notifying each of the plurality of the users of the first dimension and the second dimension prior to the image being captured.
